(19) United States
(12) Patent Application Publication
(10) Pub. No.: US 2024/0026140 A1
(43) Pub. Date: Jan. 25, 2024

(54) COMPRESSION MOLDING COMPOSITION, METHOD FOR PRODUCING THE SAME, AND MOLDED PRODUCT

(71) Applicants: THE CHEMOURSCOMPANY FC, LLC, Wilmington, DE (US); CHEMOURS-MITSUI FLUOROPRODUCTS CO., LTD, Tokyo (JP)

(72) Inventor: TSUNEO ECHIZEN, SHIZUOKA (JP)

(73) Assignee: CHEMOURS-MITSUI FLUOROPRODUCTS CO., LTD., Tokyo (JP)

(21) Appl. No.: 18/026,884

(22) PCT Filed: Sep. 17, 2021
(86) PCT No.: PCT/US2021/050767

§ 371 Date: Mar. 17, 2023

(30) Foreign Application Priority Data
Sep. 18, 2020 (JP) 2020-157155

(51) Int. Cl. C08L 27/18; B29C 43/00

(52) U.S. Cl. CPC C08L 27/18; B29C 43/003; C08L 2205/02; B29K 2027/18

(57) ABSTRACT

Provided is a compression molding composition, in which an emulsion-polymerized polytetrafluoroethylene (PTFE) and a filler are mixed in a substantially uniform manner without generating an aggregate, and the used PTFE is not particularly limited. The compression molding composition includes emulsion-polymerized polytetrafluoroethylene, a heat-processible fluoropolymer, and a filler, the melt flow rate (MFR) of the heat-processible fluoropolymer is from 0.01 to 100 g/10 min, and the content of the heat-processible fluoropolymer is from 1 to 40 mass % relative to the total of the emulsion-polymerized polytetrafluoroethylene and the heat-processible fluoropolymer.

### CROSS REFERENCE TO RELATED APPLICATION

This application is a national filing under 35 U.S.C. 371 of International Application No. PCT/US2021/050767 filed Sep. 17, 2021 and claims the benefit of priority of Japanese Patent Application No. JP2020-157155 filed Sep. 18, 2020, the disclosures of which are incorporated herein by reference in its entirety.

### FIELD OF INVENTION

The present invention relates to a compression molding composition, a method for producing the same, and a molded product.

### BACKGROUND TECHNOLOGY

Polytetrafluoroethylene (also referred to as “PTFE”) has various excellent properties such as excellent heat resistance, chemical resistance, low friction, non-tackiness, and electrical characteristics. Thus, PTFE is used as a raw material for various products taking advantage of these properties.

Two types of PTFE polymerization methods are generally known: a method for emulsion-polymerizing tetrafluoroethylene (hereinafter, also referred to as “TFE”) and a method for suspension-polymerizing tetrafluoroethylene. The PTFE obtained by these different polymerization methods differs in shape, physical properties, and the like, and therefore, is applied to molded products with different uses and molding methods.

Powdered PTFE produced by emulsion polymerization is referred to as fine powder, which is obtained by being aggregated from aqueous dispersion, and then separated the aggregate from, and drying. The fine powder has the property of being fibrillated by application of a shear force. Using the property, the fine powder is applied to paste extrusion process which mixed with an extrusion aid to form a preform, and then the preform is extruded, dried, and sintered. This enables molding of tubes, wire coverings, porous film sheets and so on. Further, a small amount of PTFE can entangle many particles, and is also used as an electrode material (binder) for a battery or a capacitor.

Powdered PTFE produced by suspension polymerization is referred to as molding powder, which is less likely to be fibrillated and is lower cost compared to fine powder. For this reason, the molding powder is applied to compression-molding process to be used for various uses, such as cutting a heat-treated cylindrical billet for various components or peeling a thin sheet (skived sheet).

Further, the molding powder can be uniformly mixed with a filler added for improving the physical properties of the molded product. For example, it is known to blend a filler for improving wear resistance and creep resistance with the molding powder and compression-mold the mixture to produce a sliding member or a sealing member.

However, the molding powder has a relatively large particle size and is hard, and therefore, is less collapsible during compression molding, generating gaps between the powder and the filler. This contributes to the generation of a void, which becomes a starting point for break at elongation. In addition, the adhesion between the resin and the filler is poor, resulting in that the filler may be separated from the molded product, causing defects during use of the molded product.

In light of such circumstances, the use of fine powder having excellent adhesion to the filler instead of molding powder has been investigated. However, the fine powder has excellent adhesion to the filler, but when mixed with a filler, disadvantageously tends to aggregate, failing to achieve uniform mixing. To address such problem, following techniques are disclosed.

Patent Document 1 discloses a method for simultaneously putting aggregated polytetrafluoroethylene powder, in which emulsion-polymerized particles obtained from an aqueous dispersion of polytetrafluoroethylene emulsion-polymerized particles by coagulation are aggregated, filler powder, and dry ice into a crushing and mixing machine, and crushing and mixing at 10° C. or lower.

Patent Document 2 discloses a method for spraying high-pressure water onto a mixture of emulsion-polymerized polytetrafluoroethylene and a filler to obtain a polytetrafluoroethylene composition in which the polytetrafluoroethylene and the filler are dispersed.

Patent Document 3 discloses a polytetrafluoroethylene composition containing a modified polytetrafluoroethylene fine powder having an extrusion pressure less than 25 MPa at RR1600 and a filler.

### PATENT DOCUMENTS

Patent Document 1: Japanese Unexamined Patent Application Publication No. 2015-151543
Patent Document 2: Japanese Patent No. 4320506
Patent Document 3: Japanese Unexamined Patent Application Publication No. 2018-109149

### SUMMARY OF THE INVENTION

Since the mixing of the emulsion-polymerized polytetrafluoroethylene with the filler needs to be performed at temperatures lower than 10° C. in Patent Document 1, and needs to be performed under injection of high-pressure water in Patent Document 2, the disclosed technologies are not necessarily satisfactory from the perspective of productivity and cost.

Further, in Patent Document 3, applicable fine powders are limited to specific modified PTFE.

An object of the present invention is to provide a compression molding composition, in which an emulsion-polymerized polytetrafluoroethylene and a filler are mixed in a substantially uniform manner without generating an aggregate even by a simple method, and the used PTFE is not particularly limited.

### Means for Resolving Problems

A compression molding composition of the present invention includes emulsion-polymerized polytetrafluoroethylene, a heat-processible fluoropolymer, and a filler, a melt flow rate (MFR) of the heat-processible fluoropolymer is from 0.01 to 100 g/10 min, and a content of the heat-processible fluoropolymer is from 1 to 40 mass % relative to the total of the emulsion-polymerized polytetrafluoroethylene and the heat-processible fluoropolymer. In the compression molding composition of the present invention, the above-described heat-processible fluoropolymer desirably includes a polymer selected from a group consisting of polytetrafluoroethylenes, tetrafluoroethylene perfluoro (alkyl vinyl ether) copolymers, tetrafluoroethylene hexafluoropropylene copolymers, tetrafluoroethylene hexafluoropropylene perfluoro (alkyl vinyl ether) copolymers, tetrafluoroethylene ethylene copolymers, polyvinylidene fluorides, polychlorotrifluoroethylenes, and chlorotrifluoroethylene ethylene copolymers.

The present invention encompasses a molded product obtained by compression molding the composition. The molded product of the present invention is desirably a sliding material or a sealing material.

The present invention encompasses a method for producing the above-described compression molding composition, the method including mixing the emulsion-polymerized polytetrafluoroethylene with the heat-processible fluoropolymer, and mixing the mixture with the filler to obtain the compression molding composition. The present invention also encompasses a method for producing the above-described compression molding composition, the method including mixing the emulsion-polymerized polytetrafluoroethylene, the heat-processible fluoropolymer, and the filler to obtain the compression molding composition.

### Effect of the Invention

In the compression molding composition of the present invention, the emulsion-polymerized polytetrafluoroethylene and the filler are mixed in a substantially uniform manner without generating an aggregate even by a simple method, and the used PTFE is not particularly limited.

### DESCRIPTION OF THE PREFERRED EMBODIMENTS

The present invention will be described in detail hereinafter. Note that, in the present specification, in the case where a numerical range is expressed using “to”, upper and lower limit values indicated by “to” are also included in the numerical range.

### Compression Molding Composition

The compression molding composition of the present invention contains emulsion-polymerized polytetrafluoroethylene, a heat-processible fluoropolymer, and a filler.

### Emulsion-Polymerized Polytetrafluoroethylene

In the present invention, “emulsion-polymerized polytetrafluoroethylene” (hereinafter, also referred to as “emulsion-polymerized PTFE”) is PTFE or modified PTFE obtained by emulsion polymerization of tetrafluoroethylene (TFE) alone or TFE together with a monomer (comonomer) capable of copolymerizing with TFE, and is a polymer that exhibits no melt fluidity. The form may be a (aqueous) dispersion or powders (fine powders). In the present invention, as necessary, a combination of different types of emulsion-polymerized PTFE may be used.

The content of the used copolymerizable monomer (comonomer) is preferably from 0.001 to 1 mass % of the total amount of monomers. Such copolymer retains high slidability of PTFE and does not exhibit fluidity at a temperature of the melting point or higher, and thus can be used without any problem even at high temperatures. When a modified PTFE is used, because the molecular chains are less likely to slip due to presence of the comonomer, the strength or elastic modulus of the polymer increases, and the creep resistance is also enhanced.

As a monomer (comonomer) that is copolymerizable with TFE contained in a modified PTFE, a monomer which contains an unsaturated bond and can be subjected to radical polymerization can be used. In order to maintain the excellent performance of the PTFE, such as heat resistance and chemical resistance, it is preferable to use a fluorine-containing monomer as a comonomer. Specific examples of comonomers include perfluoroalkenes having 3 or more carbons, preferably from 3 to 6 carbons, perfluoro (alkyl vinyl ethers) having from 1 to 6 carbons, and chlorotrifluoroethylene.

The emulsion-polymerized PTFE in the present invention can be prepared by known methods, however, a commercially available product may be used. Examples of commercially available PTFE fine powder include Teflon® PTFE 6-J, PTFE 640-J, and PTFE 641-J available from Chemours-Mitsui Fluoroproducts Co., Ltd. Examples of commercially available PTFE aqueous dispersion include Teflon® PTFE 31-JR available from Chemours-Mitsui Fluoroproducts Co., Ltd.

The average particle size of the emulsion-polymerized PTFE of the present invention is preferably from 0.1 μm to 0.5 μm for an aqueous dispersion (dispersion), and is preferably 200 μm to 800 μm for powder (fine powder). In the present specification, the average particle size of the PTFE particles in the aqueous dispersion means the particle size at an integrated value 50% (volume basis) in the particle size distribution measured by the laser diffraction/scattering method, and the average particle size of PTFE fine powder means the particle size at an integrated value 50% (volume basis) in the particle size distribution obtained by a sieving method according to ASTM D4895. In Patent Document 3, from the perspective of ease of blending (in particular, dry blending), the applicable emulsion-polymerized PTFE is limited to modified PTFE that has a small extrusion pressure, which is an indicator for fibrillation, that is, is less fibrillated. In contrast, in the present invention, PTFE and modified PTFE can be used without limitation, irrespective of ease of fibrillation. As described above, the present invention that can also use general purpose PTFE is advantageous in terms of costs. In addition, the degree of freedom of polymer selection in consideration of the physical properties imposed on the product (molded product) is increased.

### Heat-Processible Fluoropolymer

In the present invention, “heat-processible fluoropolymer” refers to a fluoropolymer that can endure the sintering temperature (approximately from 330 to 400° C.) during compression molding, melts at a melting point or higher, exhibits fluidity and processibility while in the molten phase, and has a melt flow rate (MFR) from 0.01 to 100 g/10 min. Preferably, a fluoropolymer having a melt viscosity of 1 to 100 g/10 min. The form may be a (aqueous) dispersion or a powder. Further, in the present invention, a combination of different types of heat-processible fluoropolymer can be used as necessary.

The content of the heat-processible fluoropolymer is from 1 to 40 mass %, preferably from 5 to 30 mass %, and more preferably from 8 to 22 mass % relative to the total of the emulsion-polymerized polytetrafluoroethylene and the heat-processible fluoropolymer. By setting the ratio of the heat-processible fluoropolymer to be 1 mass % or more, fibrillation of the emulsion-polymerized PTFE is prevented, thereby facilitating uniform mixing with the filler to improve performances (in particular, elongation, tensile modulus, creep resistance) of the molded product. Further, by setting the ratio of the heat-processible fluoropolymer to be 40 mass % or less, good performance of the molded product is maintained without impairing the properties (for example, slidability due to low friction properties) of the emulsion-polymerized PTFE.

The total content of the heat-processible fluoropolymer and the emulsion-polymerized polytetrafluoroethylene is from 10 to 99 vol %, preferably from 15 to 95 vol % relative to the total composition. Such content can reflect the properties of the polymer on the molded product, and decrease a concern that the molded product cannot be obtained due to brittle fracture.

Without being bound by theory, the reason for preventing the fibrillation of the emulsion-polymerized PTFE through the use of the heat-processible fluoropolymer is that the heat-processible fluoropolymer and the emulsion-polymerized PTFE are attracted to each other due to high affinity to form the state in which the fluoropolymer surrounds the emulsion-polymerized PTFE, thereby preventing the fibrillation of the PTFE when mixed with the filler.

Examples of the heat-processible fluoropolymers include melt-processible polytetrafluoroethylenes (PTFE), tetrafluoroethylene perfluoro (alkyl vinyl ether) copolymers (PFA), tetrafluoroethylene hexafluoropropylene copolymers (FEP), tetrafluoroethylene hexafluoropropylene perfluoro (alkyl vinyl ether) copolymers, tetrafluoroethylene ethylene copolymers, polyvinylidene fluorides, polychlorotrifluoroethylenes, and chlorotrifluoroethylene ethylene copolymers. When PTFE is used as the heat-processible fluoropolymer, the PTFE has melt flowability and has a melt flow rate (MFR) of at least 0.01 g/10 min, preferably 0.1 g/10 min or more.

When the intended use is a sliding component such as seal ring, among heat-processible fluoropolymers, specifically, heat-processible perfluoropolymers such as PTFE, PFA, FEP, or tetrafluoroethylene hexafluoropropylene perfluoro (alkyl vinyl ether) copolymers are preferable because of excellent slidability caused by the low surface energy thereof. Further, PFA and FEP are more preferable because of the excellent heat resistance thereof, and PFA is particularly preferable.

Further, in the examples of the heat-processible fluoropolymer described above, when fluoropolymers having substantially same melt flow rates are compared, polymers other than PTFE have a larger molecular weight and more preferable mechanical properties such as creep strength of the molded product than PTFE. Therefore, the use of the polymers other than PTFE may be preferable.

The melt flow rate (MFR) of the heat-processible fluoropolymer is preferably less than 45 g/10 min, more preferably less than 15 g/10 min, and still more preferably less than 5 g/10 min. By using a polymer having such an MFR value, mechanical properties during molding, in particular, tensile modulus and elongation are improved. Further, cracks can be prevented from occurring during molding. Note that, in the present specification, the value of the melt flow rate (MFR) is a value measured according to ASTM D-1238-13 (conditions described in ASTM D-3307-16 when the heat-processible fluoropolymer is PFA).

When PFA is used as the heat-processible fluoropolymer, the perfluoro (alkyl vinyl ether) alkyl groups in the PFA preferably have from 1 to 5 carbons, more preferably from 1 to 3 carbons. Here, the content of perfluoro (alkyl vinyl ether) in the PFA is preferably in a range of from 1 to 50 mass % of the total PFA.

The heat-processible fluoropolymer of the present invention can be prepared by known methods, but commercially available products may be used. Examples of the commercially available heat-processible fluoropolymer include Teflon® PFA MJ-103, PFA 9738-JN, PFA 334-JR, PFA 335-JR, TLP 10E-1, and MP-1300-J available from Chemours-Mitsui Fluoroproducts Co., Ltd. In addition, when preparing heat-processible PTFE, the PTFE can be obtained by normal emulsion polymerization, or can be obtained by irradiating PTFE molding powder or fine powder with radiation to degrade the powder. Specifically, it is referable to Japanese Examined Patent Application No. S47-19609, Japanese Examined Patent Application No. S52-38870, and Japanese Examined Patent Application Publication No. S56-8043.

The average particle size of the heat-processible fluoropolymer of the present invention is preferably from 10 μm to 600 μm for powder, and from 0.1 μm to 0.3 μm for aqueous dispersion (dispersion). In the present specification, the average particle size of the heat-processible fluoropolymer refers to the particle size at an integrated value 50% (volume basis) in a particle size distribution obtained by laser diffraction and scattering.

### Filler

In the present invention, “filler” refers to various organic and inorganic fillers that are powdered substances used to improve the physical properties of the molded product and can endure the firing temperature during compression molding (approximately from 330 to 400° C.).

Examples of organic fillers include engineering plastics, such as polyphenylene sulfides, polyether ether ketones, polyamides, polyimides, and the like. Examples of inorganic fillers include metal powders, metal oxides (aluminum oxide, zinc oxide, tin oxide, titanium oxide, etc.), titanic acid metallic salt, glass, ceramics, silicon carbides, silicon oxides, boron nitrides, calcium fluorides, carbon black, graphites, micas, talc, barium sulfates, molybdenum disulfide, and the like. Combinations of these can be used as necessary.

Particles of various shapes, such as particle-shaped, fiber-shaped, and flaked shaped-particles, can be used as the filler.

The content of the filler in the composition of the present invention can be appropriately set according to required characteristics for the application, the usage environment, and the like, but is preferably from 1 to 90 vol % and more preferably from 5 to 85 vol % of the total composition. When the content of the filler is 1 vol % or more, improvements in properties due to the addition of the filler can be expected. Further, by setting the content of the filler to be 90 vol % or less, the properties (for example, slidability due to low friction properties) of the emulsion-polymerized PTFE are reflected on the molded product, and there is less concern that the molded product cannot be obtained due to brittle fracture. In addition, when the content of the filler is relatively small, for example, from 1 to 30 vol % of the total composition, the possibility of fibrillation of fine powder becomes higher, while the composition of the present invention enables uniform mixing of the emulsion-polymerized PTFE (fine powder) and the filler.

The average particle size of the filler of the present invention is preferably from 1 μm to 500 μm. The average particle size refers to the particle size at an integrated value of 50% (volume basis) in the particle size distribution obtained by laser diffraction and scattering.

The filler of the present invention can be efficiently mixed with emulsion-polymerized PTFE (in particular fine powder) by a simple dry blending method rather than wet mixing, and therefore, the filler can be used as having a wide range of specific gravity. In addition, a metal filler is easily released into water by wet mixing but can be used without problems in the present invention.

### Optional Additives

The composition of the present invention may contain one type or two or more types of various additives such as solid lubricants, oxidation stabilizers, heat-resistant stabilizers, weather-resistant stabilizers, flame retardants, and pigments. As an additional component, blending a solid lubricant by a few percents is useful for enhancing the self-lubricating properties. Examples of the solid lubricant include graphite, molybdenum disulfide, and boron nitride. In addition, pigments and various additives may also be added in accordance with the required properties such as conductivity and foam prevention.

As described above, in the composition of the present invention, it is possible to uniformly mix the emulsion polymerized PTFE with the filler. When the emulsion-polymerized PTFE is fibrillated upon mixing, an imbalance of the filler occurs in the composition, which adversely affects the performances of the molded product. In particular, when the content of the filler is relatively small such as from 1 to 30 vol % of the total composition, the likelihood of fibrillation of the fine powder becomes high. Even in this case, the composition of the present invention enables uniform mixing of the emulsion-polymerized PTFE (in particular, fine powder) and the filler, suppressing defects caused by the generation of aggregate during production of the molded product.

### Method for Producing Composition

The compression molding composition of the present invention can be produced by various known methods.

The composition of the present invention can be produced by a method including mixing an emulsion-polymerized PTFE and a heat-processible fluoropolymer, and mixing the mixture with a filler to obtain a compression molding composition.

The emulsion-polymerized PTFE can be mixed with the heat-processible fluoropolymer by various known methods. Examples of the known methods include a method for stirring and coagulating an emulsion-polymerized PTFE and a heat-processible fluoropolymer in a dispersion state (co-coagulation and coaggregation), and a method for mixing dry fine powder and a heat-processible fluoropolymer (dry blending and dry mixing), or a flow mixing method using a turbuler mixer or the like that rolls a mixing container itself for stirring.

The mixture of the emulsion-polymerized PTFE and the heat-processible fluoropolymer can be also mixed with the filler by various known methods, but it is preferable to use a simple dry blending. Note that when the emulsion-polymerized PTFE is mixed with the heat-processible fluoropolymer by co-coagulation and coaggregation, the obtained mixture can be appropriately dried, and the dried powder can be dry blended with the filler.

Further, the compression molding composition of the present invention can be produced by simultaneously adding and mixing the emulsion-polymerized PTFE, the heat-processible fluoropolymer, and the filler. Dry blending can be used as the mixing method. Since dry blending can be performed under dry conditions using no liquid medium such as water or an organic solvent, mixing is easily completed in a short period of time, which is highly productive and preferable. Dry blending also has the advantage that there is no restriction on use for fillers that are difficult to be mixed in wet blending, such as metal fillers.

Further, by the present invention, even when dry blending is performed with high speed stirring, generation of aggregates is suppressed, enabling uniform mixing in a short period of time.

Examples of a device used for dry blending include, but are not limited to, a cutter mixer, a Henschel mixer, a V-type blender with a chopper, a double-cone mixer with a chopper, and a rocking mixer.

When the rotational speed and the peripheral speed of the stirring blades and the like used for dry blending in the present invention are high, uniform mixing is achieved in a short period of time, which is preferable. Specifically, even when the peripheral speed of the stirring blades is as high as 150 m/s or higher, mixing in the composition of the present invention is performed without problems.

### Molded Product and Method for Producing the Same

The “molded product” of the present invention refers to a product obtained by compression-molding a composition of the present invention.

The molded product of the present invention has excellent heat resistance and chemical resistance, as well as improved wear resistance and creep resistance due to blending of various fillers and therefore, can be applied to various uses requiring these characteristics. In particular, the molded product is preferably used as a sliding material or a sealing material that mainly uses molding powder. Sliding uses include bearings, rolls, piston rings, oil seal rings (the piston ring and the oil seal ring slide relative to the housing), and sealing uses include packings such as oil sealing rings, piston rings, mechanical seals, and belloframs, and gaskets classified as fixed seals such as O-rings. In particular, in order to follow minute movements, when subjected to a load, the oil sealing ring of the automobile engine is required to deform without being damaged by cracks. The composition of the present invention contains the more flexible emulsion-polymerized PTFE than molding powder, and the uniformly dispersed filler that contributes to an improvement in strength, and thus, is suitable for the above-mentioned use. In addition, in the present invention, since high content of the filler is possible, the molded product can be applied to uses such as high heat conductive members used in power semiconductor substrates and packages, electrically conductive members, electrode members of batteries, electronic device materials such as magnetic coils, and the like.

As described above, the composition of the present invention allows uniform mixing of the emulsion-polymerized PTFE and the filler, suppressing defects caused by aggregation of the emulsion-polymerized PTFE and the filler. Thus, in the molded product obtained from such composition, even when a small amount of filler is used, the filler is uniformly dispersed, resulting in that the properties (for example, creep resistance properties) of the filler that compensate for the performance of the emulsion-polymerized PTFE can be sufficiently exhibited. Further, the emulsion-polymerized PTFE is more flexible than the molding powder, and has good adhesion to fillers. As a result, the molded product has excellent tensile properties and compression characteristics. It is also believed to decrease release of the filler from the molded product, suppress the occurrence of defects during use, and improve wear characteristics. Moreover, the pressure applied at compression molding of the composition, described below, can be reduced as compared to the case of using molding powder.

The molded product of the present invention is produced by a known method, that is, a method for filling the composition of the present invention into a mold, and pressurizing and heating the filled composition to mold the composition (compression molding).

Here, at filling into the mold, to facilitate the filling, the composition of the present invention is preferably powder or granule held at a crystal transition temperature (approximately 19° C. in the case of PTFE) or higher. Additionally, the filled composition can be pressurized under a pressure of 200 kgf/cm² or more using a ram (pressing bar) or the like. A higher upper limit of the pressure is preferable from the perspective of moldability, but the emulsion-polymerized PTFE composition of the present invention can be molded with a relatively lower pressure than the molding powder. Further, as the heating method, for example, the temperature may be increased to approximately 330 to 400° C., and maintained until sintering becomes uniform throughout, and then cooled to room temperature.

Hot pressing that simultaneously performs heating and pressing can be also used, but from the perspective of productivity, a method for pressure-molding the composition filled in the mold, and heating and firing the obtained molded product is preferable.

PTFE fine powder (or a composition comprising the same) has been used primarily as a raw material for paste extrusion that extrudes a mixture with lubricating oil into a paste form at low temperatures (less than 75° C.). According to this molding method, a rod or sheet-shaped molded product having excellent strength can be obtained by taking advantage of the property that PTFE fine powder is fibrillated (fibrilized) under a shear force. However, with this molding method, it is difficult to obtain a molded product other than a specific shape. In addition, since the lubricating oil must be removed after paste extrusion, the lubricating oil remaining on the molded product is carbonized, leading to problems such as decreases in coloration, chemical resistance, and electrical properties of the molded product. There is another manufacturing problem that, in order to prevent cracks of the molded product due to bumping of the lubricating oil, the lubricating oil must be removed by gradually increasing the temperature.

In contrast, according to the present invention, PTFE fine powder can be applied to a compression molded product. So far, molding powder has been widely used as a raw material for a compression molded product. In other words, PTFE fine powder tends to aggregate upon mixing with the filler and cannot be uniformly mixed, thereby rendering the application to the compression molded product unsuitable. However, when the composition of the present invention is used as the material for the molded product, the generation of aggregate is suppressed, enabling uniform mixing of the emulsion-polymerized PTFE and the filler. As a result, the emulsion-polymerized PTFE that has been unsuitable for the raw material for the compression molded product can be used. In addition, as compared to the molding powder currently used as a raw material for the compression molded product, the adhesion to the filler is improved, thereby enhancing various physical properties of the molded product.

### EXAMPLES

The present invention will be described below in further detail by presenting examples and comparative examples; however, the present invention is not limited to these examples.

The following raw materials were used in the examples and comparative examples.

### PTFE Fine Powder

Teflon® PTFE 6-J (available from Chemours-Mitsui Fluoroproducts Co., Ltd., SSG: 2.214, average particle size: approximately 450 μm)

Teflon® PTFE 640-J (available from Chemours-Mitsui Fluoroproducts Co., Ltd., SSG: 2.162, average particle size: approximately 500 μm)

6-J is unmodified PTFE and 640-J is modified PTFE.

### Emulsion-Polymerized PTFE Aqueous Dispersion

Tetrafluoroethylene was emulsion-polymerizing by the method according to Examples 5 to 7 described in Japanese Patent No. 5588679 to obtain emulsion-polymerized PTFE aqueous dispersion having a polymer solid content of 45 mass % and an average particle size of 0.23 μm.

Specifically, 2.1 L of pure water, 60 g of paraffin wax, 20 g of an ammonium salt of fluoromonoether acid represented by CF₃CF₂CF₂OCF(CF₃)COOH as a surfactant, 0.15 g of ammonium salt of perfluoropolyether acid represented by C₃F₇O(CFCF₃CF₂O)ₙCFCF₃COOH having a number average molecular weight of approximately 1500, and 0.04 g of methyl alcohol as a chain transfer agent were prepared in a clean cylindrical stainless steel container with a volume of 3.8 L and a horizontal stirrer blade. Next, after oxygen was removed from the system, TFE was introduced at a temperature of 87° C. in the system, and the total pressure was set to 2.35 MPa. 100 g of initiator aqueous solution containing 0.006 g of ammonium persulfate and 1.4 g of disuccinic acid peroxide was introduced thereto to initiate polymerization. After the start of polymerization, TFE was continuously injected to keep the pressure at 2.55 MPa, and stirring was stopped when 1700 g of TFE was injected to obtain PTFE aqueous dispersion having a polymer solid content of approximately mass %.

### PTFE Molding Powder

Teflon® PTFE 7-J (available from Chemours-Mitsui Fluoroproducts Co., Ltd., SSG: 2.166, average particle size: approximately μm)

### Heat-Processible Fluoropolymer Aqueous Dispersion

PFA Aqueous Dispersion (I)

A dispersion of tetrafluoroethylene perfluoropropyl vinyl ether (TFE/PPVE) copolymer (MFR of solid polymer=approximately 2 g/10 min, average particle size: approximately 0.21 μm) was prepared by the method according to Examples 1 to 3 described in Japanese Patent No. 5588679.

Specifically, 2.1 L of pure water, 17 g of 50 mass % aqueous solution of fluoromonoether acid represented by CF₃CF₂CF₂OCF(CF₃)COOH as a surfactant, and 150 g of aqueous solution containing 0.18 g of ammonium salt of perfluoropolyether acid represented by C₃F₇O(CFCF₃CF₂O)ₙCFCF₃COOH having a number average molecular weight of approximately 1500 were prepared in a clean cylindrical stainless steel container with a volume of 3.8 L and a horizontal stirrer blade. Then, after removing oxygen from the system, ethane was injected as a chain transfer agent at a pressure of 0.03 MPa, and then 60 g of PPVE was added and the temperature in the system was set to 70° C. Next, TFE was introduced and the container pressure was 2.1 MPa. 100 g of aqueous solution containing 0.18 g of ammonium persulfate was introduced to initiate polymerization. After the start of polymerization, TFE and ammonium persulfate aqueous solution, PPVE were continuously injected so as to keep the pressure of 2.1 MPa, and stirring was stopped when 1000 g of TFE, 55 g of aqueous solution containing 0.017 g of ammonium persulfate, and 35 g of PPVE were injected to obtain PFA dispersion (I) with a polymer solid content of approximately 31 mass %.

PFA Aqueous Dispersion (II)

A dispersion of tetrafluoroethylene perfluoroethyl vinyl ether (TFE/PEVE) copolymer (MFR of solid polymer=approximately 44 [g/10 min], average particle size: approximately 0.20 μm) was prepared by the method according to Examples 1 to 3 described in Japanese Patent No. 5588679.

Specifically, 2.0 L of pure water, 15 g of 50 mass % aqueous solution of fluoromonoether acid represented by CF₃CF₂CF₂OCF(CF₃)COOH as a surfactant, and 200 g of aqueous solution containing 0.24 g of ammonium salt of perfluoropolyether acid represented by C₃F₇O(CFCF₃CF₂O)ₙCFCF₃COOH having a number average molecular weight of approximately 1500 were prepared in a clean cylindrical stainless steel container with a volume of 3.8 L and a horizontal stirrer blade. Then, after removing oxygen from the system, ethane was injected as a chain transfer agent at a pressure of 0.03 MPa, and then 70 g of PEVE was added and the temperature in the system was set to 80° C. Next, TFE was introduced and the container pressure was 2.1 MPa. 50 g of aqueous solution containing 0.18 g of ammonium persulfate was introduced to initiate polymerization. After the start of polymerization, TFE and ammonium persulfate aqueous solution, PEVE were continuously injected so as to keep the pressure of 2.1 MPa, and stirring was stopped when 1000 g of TFE, 85 g of aqueous solution containing 0.15 g of ammonium persulfate, and 61 g of PEVE were injected to obtain PFA dispersion (II) with a polymer solid content of approximately 31 mass %.

### Heat-Processible Fluoropolymer Powder

Teflon® PFA MJ-103 (available from Chemours-Mitsui Fluoroproducts Co., Ltd., MFR=about 2 μg/10 min, average particle size: approximately 20 μm)

### Filler

Artificial graphite (available from Oriental Industry Co., Ltd. AT-NO. 10E: specific gravity 2.2, average particle size 25 μm)
Spheroidized graphite (Shin-Etsu Chemical Co., Ltd., WF-015: specific gravity 2.23 to 2.26, average particle size 15 μm)

### Manufacturing of Molded Product

### Example 1

The PTFE aqueous dispersion described above and the PFA aqueous dispersion (I) described above were placed in an 8 L tank provided with a baffle plate such that the mass ratio of the PTFE and the PFA was 99:1, and the total of the mass of these polymers was 600 g, and purified water was put thereinto such that the total mass was 4805 g.

Next, the mixture was stirred for 1 minute at 300 rpm using a downflow type propeller stirrer with six blades, and then 195 g of an aqueous solution of ammonium carbonate prepared in 12% was added and the rotational speed was increased to 600 rpm. Stirring was continued until an aggregate was formed, and then stirring was stopped and the aggregate was separated from water separated using gauze. The aggregate was placed on a tray and dried at 150° C. for 10 hours or more to obtain dried powder of the agglomerate.

149 g of a coaggregate obtained by the above-mentioned method and 26 g of artificial graphite (AT-NO.10E available from Oriental Industry Co., Ltd.), which was a filler, were injected into Wonder Crush Mill D3V-10 (available from Osaka Chemical Co., Ltd., stirring blade diameter: 142 mm), which was a mill with stirring blade. After stirring for 10 seconds at 25000 rpm, powder attached to a gap between the container and a lid was scraped off using a spatula, and then stirred for 30 seconds at 25000 rpm to obtain a mixed composition.

The obtained composition was placed in a metal mold having a diameter of 50 mm and pre-molded by pressurization at 400 kgf/cm², and this was then fired for three hours at 370° C. in an electric furnace to obtain a cylindrical molded product having a height of approximately 40 mm.

### Example 2

A molded product was produced in the same manner as in Example 1 with the exception that the mass ratio of the PTFE and the PFA was 95:5.

### Example 3

A molded product was produced in the same manner as in Example 1 with the exception that the mass ratio of the PTFE and the PFA was 90:10.

### Example 4

A molded product was produced in the same manner as in Example 1 with the exception that the mass ratio of the PTFE and the PFA was 80:20.

### Example 5

A molded product was produced in the same manner as in Example 1 with the exception that the mass ratio of the PTFE to the PFA was 60:40.

### Example 6

A molded product was produced using the same manner as Example 1 with the exception that PFA aqueous dispersion (II) was used in place of the PFA aqueous dispersion (I) and the mass ratio of the PTFE and the PFA was 90:10.

### Example 7

149 g of powdered PTFE 6-J and PFA MJ-103 was injected into Wonder Crush Mill D3V-10 (available from Osaka Chemical Co., Ltd., stirring blade diameter: 142 mm), which was a mill with stirring blade, such that the mass ratio of the PTFE 6-J to the PFA MJ-103 is 99:1, and 26 g of artificial graphite (AT-NO. 14E available from Oriental Industry Co., Ltd.), which was a filler, was further added, and the mixture was stirred under the same conditions as in Example 1 to obtain a mixed composition.

The obtained composition was placed in a metal mold having a diameter of 50 mm and pre-molded by pressurization at 400 kgf/cm², and this was then fired for three hours at 370° C. in an electric furnace to obtain a cylindrical molded product having a height of approximately 40 mm.

### Example 8

A molded product was produced in the same manner as in Example 7 with the exception that the mass ratio of the PTFE 6-J and the PFA MJ-103 was 95:5.

### Example 9

A molded product was produced in the same manner as in Example 7 with the exception that the mass ratio of the PTFE 6-J and the PFA MJ-103 was 90:10.

### Example 10

A molded product was produced in the same manner as in Example 7 with the exception that the mass ratio of the PTFE 6-J and the PFA MJ-103 was 80:20.

### Example 11

A molded product was produced in the same manner as in Example 7 with the exception that the mass ratio of the PTFE 6-J and the PFA MJ-103 was 60:40.

### Example 12

A mixed composition was obtained by the same manner as in Example 1 with the exception that the mass ratio of the PTFE and the PFA was 80:20 and 105 g of the spherical graphite was used as the filler for 70 g of the obtained coaggregate.

The obtained composition was placed in a metal mold having a diameter of 50 mm and pre-molded by pressurization at 600 kgf/cm², and this was then fired for three hours at 370° C. in an electric furnace to obtain a cylindrical molded product having a height of approximately 40 mm.

### Example 13

A mixed composition was obtained by the same manner as in Example 1 with the exception that the mass ratio of the PTFE and the PFA was 80:20 and 140 g of the spherical graphite was used as the filler for 35 g of the obtained coaggregate.

The obtained composition was placed in a metal mold having a diameter of 50 mm and pre-molded by pressurization at 700 kgf/cm², and this was then fired for three hours at 370° C. in an electric furnace to obtain a cylindrical molded product having a height of approximately 40 mm.

### Comparative Example 1

149 g of powdered PTFE 6-J was injected into Wonder Crush Mill D3V-10 (available from Osaka Chemical Co., Ltd., stirring blade diameter: 142 mm), which was a mill with stirring blade, and 26 g of artificial graphite (AT-NO. 14E available from Oriental Industry Co., Ltd.), which was a filler, were injected, and the mixture was stirred under the same conditions as in Example 1 to obtain a mixed composition.

The obtained composition was placed in a metal mold having a diameter of 50 mm and pre-molded by pressurization at 400 kgf/cm², and this was then fired for three hours at 370° C. in an electric furnace to obtain a cylindrical molded product having a height of approximately 40 mm.

### Comparative Example 2

A molded product was produced in the same manner as in Comparative Example 1 with the exception that PTFE 640-J was used in place of the PTFE 6-J.

### Comparative Example 3

A molded product was produced by the same method as in Comparative Example 1 with the exception that PTFE 7-J, which is PTFE molding powder, was used in place of the PTFE 6-J.

### Comparative Example 4

A molded product was produced by the same method as in Example 7 with the exception that PTFE 7-J, which is PTFE molding powder, was used in place of the PTFE 6-J, and the mass ratio of the PTFE 7-J and the PFA MJ-103 was 95:5.

### Comparative Example 5

A molded product was produced by the same method as in Example 7 with the exception that PTFE 7-J, which is PTFE molding powder, was used in place of the PTFE 6-J, and the mass ratio of the PTFE 7-J and the PFA MJ-103 was 90:10.

### Comparative Example 6

A molded product was produced by the same method as in Example 7 with the exception that PTFE 7-J, which is PTFE molding powder, was used in place of the PTFE 6-J, and the mass ratio of the PTFE 7-J and the PFA MJ-103 was 80:20.

### Comparative Example 7

A molded product was produced by the same method as in Example 7 with the exception that PTFE 7-J, which is PTFE molding powder, was used in place of the PTFE 6-J, and the mass ratio of the PTFE 7-J and the PFA MJ-103 was 60:40.

### Comparative Example 8

A mixed composition was obtained by the same method as in Comparative Example 1 with the exception that 70 g of PTFE 7-J, which is PTFE molding powder, was used in place of 149 g of PTFE 6-J, and 105 g of the spherical graphite was used as the filler.

The obtained composition was placed in a metal mold having a diameter of 50 mm and pre-molded by pressurization at 600 kgf/cm², and this was then fired for three hours at 370° C. in an electric furnace to obtain a cylindrical molded product having a height of approximately 40 mm.

### Comparative Example 9

A molded product was obtained by the same method as in Comparative Example 1 with the exception that 35 g of PTFE 7-J, which is PTFE molding powder, was used in place of 149 g of PTFE 6-J, and 140 g of spherical graphite was used.

The obtained composition was placed in a metal mold having a diameter of 50 mm and pre-molded by pressurization at 700 kgf/cm², and this was then fired for three hours at 370° C. in an electric furnace to obtain a cylindrical molded product having a height of approximately 40 mm.

### Evaluation of Dispersibility

A sheet having a thickness of 0.3 mm was produced by skiving from the cylindrical molded products obtained in the Examples and Comparative Examples, and the dispersibility was evaluated by performing transmission light observation to confirm the presence or absence of white spots in a range of approximately 40 mm width and 3500 mm length. When no white spot was observed, the dispersibility was considered as “favorable”, and when white spots were observed, the dispersibility was considered as “poor”. The results are described in Tables 1 to 4.

TABLE 1

| | | Example 1 | Example 2 | Example 3 | Example 4 | Example 5 | Example 6 |
|---|---|---|---|---|---|---|---|
| Compo- | PTFE/ | Dispersion/ | Dispersion/ | Dispersion/ | Dispersion/ | Dispersion/ | Dispersion/ |
| sition | Mass % | 84.15 | 80.75 | 76.50 | 68.00 | 51.00 | 76.50 |
| | Heat- | Dispersion | Dispersion | Dispersion | Dispersion | Dispersion | Dispersion |
| | processible | (I)/ | (I)/ | (I)/ | (I)/ | (I)/ | (II)/ |
| | fluoropolymer/ | 0.85 | 4.25 | 8.50 | 17.00 | 34.00 | 8.50 |
| | Mass % | | | | | | |
| | Filler | Artificial | Artificial | Artificial | Artificial | Artificial | Artificial |
| | (Graphite)/ | graphite/ | Graphite/ | Graphite/ | Graphite/ | Graphite/ | Graphite/ |
| | Mass % | 15 | 15 | 15 | 15 | 15 | 15 |
| | (Vol %) | (15.1) | (15.1) | (15.1) | (15.0) | (14.9) | (15.1) |
| | Content of | 1 | 5 | 10 | 20 | 40 | 10 |
| | Heat- | | | | | | |
| | processible | | | | | | |
| | fluoropolymer | | | | | | |
| | Relative to | | | | | | |
| | Total of PTFE | | | | | | |
| | and Heat- | | | | | | |
| | processible | | | | | | |
| | fluoropolymer/ | | | | | | |
| | Mass % | | | | | | |

| | | | | | | |
|---|---|---|---|---|---|---|
| Method for Mixing | Coaggregation | Coaggregation | Coaggregation | Coaggregation | Coaggregation | Coaggregation |
| PTFE and Heat- | | | | | | |
| processible | | | | | | |
| fluoropolymer | | | | | | |
| Dispersibility | Favorable | Favorable | Favorable | Favorable | Favorable | Favorable |

TABLE 2

| | | Example 7 | Example 8 | Example 9 | Example 10 | Example 11 | Example 12 |
|---|---|---|---|---|---|---|---|
| Composition | PTFE/ | 6-J/ | 6-J/ | 6-J/ | 6-J/ | 6-J/ | Dispersion/ |
| | Mass % | 84.15 | 80.75 | 76.50 | 68.00 | 51.00 | 32.00 |
| | Heat-processible | MJ-103/ | MJ-103/ | MJ-103/ | MJ-103/ | MJ-103/ | Dispersion |
| | fluoropolymer/ | 0.85 | 4.25 | 8.50 | 17.00 | 34.00 | (I)/8.00 |
| | Mass % | | | | | | |
| | Filler (Graphite)/ | Artificial | Artificial | Artificial | Artificial | Artificial | Spheroidized |
| | Mass % | Graphite/ | Graphite/ | Graphite/ | Graphite/ | Graphite/ | Graphite/ |
| | (Vol %) | 15 | 15 | 15 | 15 | 15 | 60 |
| | | (15.1) | (15.1) | (15.1) | (15.0) | (14.9) | (60.0) |
| | Content of | 1 | 5 | 10 | 20 | 40 | 20 |
| | Fluoropolymer | | | | | | |
| | Relative to | | | | | | |
| | Total of | | | | | | |
| | PTFE and | | | | | | |
| | Fluoropolymer/ | | | | | | |
| | Mass % | | | | | | |

| | | | | | | |
|---|---|---|---|---|---|---|
| Method for Mixing PTFE | Dry Blend | Dry Blend | Dry Blend | Dry Blend | Dry Blend | Coaggregation |
| and Heat-processible | | | | | | |
| fluoropolymer | | | | | | |
| Dispersibility | Favorable | Favorable | Favorable | Favorable | Favorable | Favorable |

TABLE 3

| | | | Comparative | Comparative | Comparative | Comparative | Comparative |
|---|---|---|---|---|---|---|---|
| | | Example 13 | Example 1 | Example 2 | Example 3 | Example 4 | Example 5 |
| Composition | PTFE/ | Dispersion/ | 6-J/ | 640-J/ | 7-J/ | 7-J/ | 7-J/ |
| | Mass % | 16.0 | 85.0 | 85.0 | 85.0 | 80.75 | 6.5 |
| | Heat- | Dispersion (I)/ | — | — | — | MJ-103/ | MJ-103/ |
| | processible | 4.00 | | | | 4.25 | 8.50 |
| | fluoropolymer/ | | | | | | |
| | Mass % | | | | | | |
| | Filler | Spheroidized | Artificial | Artificial | Artificial | Artificial | Artificial |
| | (Graphite)/ | Graphite/ | Graphite/ | Graphite/ | Graphite/ | Graphite/ | Graphite/ |
| | Mass % | 80 | 15 | 15 | 15 | 15 | 15 |
| | (Vol %) | (80.0) | (15.1) | (14.8) | (14.8) | (14.8) | (14.8) |
| | Content of | 20 | — | — | — | 5 | 10 |
| | Fluoropolymer | | | | | | |
| | Relative to | | | | | | |
| | Total of PTFE | | | | | | |
| | and | | | | | | |
| | Fluoropolymer/ | | | | | | |
| | Mass % | | | | | | |

| | | | | | | |
|---|---|---|---|---|---|---|
| Method for Mixing PTFE | Coaggregation | — | — | — | Dry Blend | Dry Blend |
| and Heat-processible | | | | | | |
| fluoropolymer | | | | | | |
| Dispersibility | Favorable | Poor | Poor | Favorable | Favorable | Favorable |

TABLE 4

| | | Comparative | Comparative | Comparative | Comparative |
|---|---|---|---|---|---|
| | | Example 6 | Example 7 | Example 8 | Example 9 |
| Composition | PTFE/Mass % | 7-J/68.0 | 7-J/51.0 | 7-J/40.0 | 7-J/20.0 |
| | Heat-processible | MJ-103/17.00 | MJ-103/34.00 | — | — |
| | fluoropolymer/Mass % | | | | |
| | Filler | Artificial | Artificial | Spheroidized | Spheroidized |
| | (Graphite)/Mass % | Graphite/15 | Graphite/15 | Graphite/60 | Graphite/80 |
| | (Vol %) | (14.8) | (14.7) | (59.6%) | (79.7%) |
| | Content of Fluoropolymer | 20 | 40 | — | — |
| | Relative to Total of PTFE | | | | |
| | and Fluoropolymer/Mass % | | | | |

| | | | | |
|---|---|---|---|---|
| Method for Mixing PTFE and Heat- | Dry Blending | Dry Blending | — | — |
| processible fluoropolymer | | | | |
| Dispersibility | Favorable | Favorable | Favorable | Favorable |

In Examples 1 to 13, in which the emulsion-polymerized PTFE was used as PTFE and the heat-processible fluoropolymer was further blended, dispersibility was favorable without fibrillation. In contrast, in Comparative Examples 1 and 2, in which fine powder was used but the heat-processible fluoropolymer was not blended, an aggregate was generated upon mixing with the filler, and dispersibility was poor.

Surprisingly, even when dry blending of simultaneously mixing the PTFE, the heat-processible fluoropolymer, and the filler was adopted (Example 7 to 11), uniform dispersion could be achieved.

### Evaluation of Molded Product

The molded products were evaluated by the following method using the cylindrical molded products produced in Examples 1 to 13 and Comparative Examples 3 to 8, which exhibited favorable dispersibility. Note that the molded product obtained in Comparative Example 9 was brittle, failing to produce the test piece and thus, evaluation was not performed.

### (Tensile Test: Tensile Strength (at Break), Elongation, Tensile Modulus, Yield Point Strength)

The obtained cylindrical molded products were cut to have a thickness of 2 mm, and obtained discs were punched into a dumbbell shape according to ASTM D-1708, and a tensile test was performed.

### Compression Creep Test

A cube with 12.7±0.5 mm in length, width, and height was cut from each of the obtained cylindrical molded product to form a test piece.

The obtained test pieces were measured using a 6-line compression creep tester (available from Orientec Co., Ltd.) according to ASTM D-621.

For 60 minute deformation, compression creep was measured after holding at temperature of 23° C. and a load of 140 kgf/cm² for 1 hour.

For 24 hour deformation, compression creep was measured after holding at temperature of 23° C. and a load of 140 kgf/cm² for 24 hours.

For permanent deformation, compression creep was measured after holding at a temperature of 23° C. and a load of 140 kgf/cm² for 24 hours and subsequent still standing at room temperature (23° C.) and no load for 24 hours.

MD represents the compression direction and CD represents creep deformation in a direction perpendicular to the compression direction.

Results of the tensile test (tensile strength (at break), elongation, tensile modulus, yield point strength), and the compression creep test are illustrated in Tables 5 to 8. However, the compression creep test was not performed for Examples 12 and 13 and Comparative Example 8.

TABLE 5

| | | Example 1 | Example 2 | Example 3 | Example 4 | Example 5 |
|---|---|---|---|---|---|---|
| Tensile Test | Tensile Strength | 17.8 | 18.8 | 19.1 | 20.1 | 19.7 |
| | (At break) [MPa] | | | | | |
| | Elongation [%] | 277 | 297 | 325 | 355 | 334 |
| | Tensile Modulus [%] | 730 | 713 | 740 | 704 | 651 |
| | Yield Point Strength | 13.4 | 13.7 | 14.6 | 15.3 | 16.2 |
| | (MPa) | | | | | |
| Compression | MD 60 Minute | 5.7 | 4.7 | 3.9 | 3.2 | 2.7 |
| Creep Test | Deformation [%] | | | | | |
| | MD 24 Hour | 7.6 | 6.0 | 4.9 | 4.1 | 3.3 |
| | Deformation [%] | | | | | |
| | MD Permanent | 4.9 | 3.4 | 2.5 | 1.7 | 1.1 |
| | Deformation [%] | | | | | |
| | CD 60 Minute | 6.1 | 5.1 | 4.5 | 3.7 | 3.1 |
| | Deformation [%] | | | | | |
| | CD 24 Hour | 8.4 | 6.8 | 5.8 | 4.8 | 3.7 |
| | Deformation [%] | | | | | |
| | CD Permanent | 5.4 | \|3.8 | \|3.0 | 2.0 | 1.3 |
| | Deformation [%] | | | | | |

TABLE 6

| | | Example 6 | Example 7 | Example 8 | Example 9 | Example 10 |
|---|---|---|---|---|---|---|
| Tensile Test | Tensile Strength | 17.7 | 18.6 | 19.2 | 19.9 | 20.3 |
| | (At break) [MPa] | | | | | |
| | Elongation [%] | 283 | 259 | 261 | 290 | 313 |
| | Tensile Modulus [%] | 748 | 794 | 817 | 806 | 730 |
| | Yield Point Strength | 14.4 | 14.1 | 14.6 | 14.8 | 15.3 |
| | (MPa) | | | | | |
| Compression | MD 60 Minute | 4.3 | 5.3 | 4.7 | 4.0 | 3.6 |
| Creep Test | Deformation [%] | | | | | |
| | MD 24 Hour | 5.4 | 7.1 | 6.2 | 5.0 | 4.5 |
| | Deformation [%] | | | | | |
| | MD Permanent | 3.0 | 4.3 | 3.2 | 2.4 | 1.9 |
| | Deformation [%] | | | | | |
| | CD 60 Minute | 4.8 | 5.3 | 4.8 | 4.4 | 3.8 |
| | Deformation [%] | | | | | |
| | CD 24 Hour | 6.3 | 7.3 | 6.3 | 5.7 | 4.8 |
| | Deformation [%] | | | | | |
| | CD Permanent | 3.5 | 4.3 | 3.3 | 2.8 | 2.0 |
| | Deformation [%] | | | | | |

TABLE 7

| | | Example | Example | Example | Comparative | Comparative |
|---|---|---|---|---|---|---|
| | | 11 | 12 | 13 | Example 3 | Example 4 |
| Tensile Test | Tensile Strength | 19.5 | 17.7 | 8.5 | 23.7 | 25.4 |
| | (At break) [MPa] | | | | | |
| | Elongation [%] | 315 | 3.75 | 1.36 | 276 | 275 |
| | Tensile Modulus [%] | 679 | 1366 | 892 | 571 | 581 |
| | Yield Point Strength | 15.7 | 17.4 | 8.3 | 14.9 | 15.9 |
| | (MPa) | | | | | |
| Compression | MD 60 Minute | 3.4 | — | — | 5.9 | 5.7 |
| Creep Test | Deformation [%] | | | | | |
| | MD 24 Hour | 4.1 | — | — | 8.2 | 7.5 |
| | Deformation [%] | | | | | |
| | MD Permanent | 1.4 | — | — | 4.2 | 3.2 |
| | Deformation [%] | | | | | |
| | CD 60 Minute | 3.4 | — | — | 6.5 | 6.2 |
| | Deformation [%] | | | | | |
| | CD 24 Hour | 14.1 | — | — | 8.9 | 8.2 |
| | Deformation [%] | | | | | |
| | CD Permanent | 1.4 | — | — | 4.5 | 3.6 |
| | Deformation [%] | | | | | |

TABLE 8

| | | Comparative | Comparative | Comparative | Comparative |
|---|---|---|---|---|---|
| | | Example 5 | Example 6 | Example 7 | Example 8 |
| Tensile Test | Tensile Strength | 25.3 | 23.8 | 21.4 | 7.2 |
| | (At break) [MPa] | | | | |
| | Elongation [%] | 282 | 290 | 283 | 1.27 |
| | Tensile Modulus [%] | 590 | 579 | 599 | 743 |
| | Yield Point Strength (MPa) | 16 | 15.4 | 15.6 | 7.1 |
| Compression | MD 60 Minute Deformation [%] | 5.5 | 4.9 | 4.0 | — |
| Creep Test | MD 24 Hour Deformation [%] | 7.2 | 6.2 | 4.9 | — |
| | MD Permanent Deformation [%] | 3.0 | 2.3 | 1.6 | — |
| | CD 60 Minute Deformation [%] | 5.9 | 5.1 | 4.1 | — |
| | CD 24 Hour Deformation [%] | 7.7 | 6.6 | 5.0 | — |
| | CD Permanent Deformation [%] | 3.3 | 2.6 | 1.7 | — |

As compared to the molded products in Comparative Example 3 to 8 using molding powder, the molded products in Example 1 to 12, in which the emulsion-polymerized PTFE was used as PTFE and the heat-processible fluoropolymer was further blended had higher elongation and tensile elastic modulus, and smaller creep deformation. Note that when PFA aqueous dispersion (I) and PFA MJ-103 with lower viscosity (fluidity) during melting were used as the heat-processible fluoropolymer, the above-mentioned tendency became remarkable. In these results, adhesion between the polymer and the filler was improved by using the emulsion-polymerized PTFE (fine powder or emulsion-polymerized PTFE aqueous dispersion) as the PTFE. Further, the molded product in Example 12, which had a high filler content of 60 mass %, significantly improved tensile properties as compared to the molded product in Comparative Example 8 with the same content. Further, in the case of the filler having a high content of 80 mass %, the molded product was obtained in the present invention (Example 13), while in Comparative Example 9 using molding powder, the molded product was brittle, failing to produce a test piece.

In this way, high elongation can prevent breakage caused by cracks of the molded product when subjected to a load. In addition, high tensile modulus can prevent elongation breakage of the molded product when subjected to a load. Further, small creep deformation means less deformation during long-term use even in environments where a high pressure is continuously applied, enabling stable use. As a result, for example, when a sliding member or sealing member is produced by compression molding using the composition of the present invention, the effect of suppressing displacement of the polymer from the filler when a load is applied to a sliding surface or sealing surface of the product can be expected. Moreover, in the present invention, the molded product can be obtained without problems even if the content of the filler is high at 80 mass % and therefore, the composition is applicable to various uses. For example, the present invention is thought to be useful for high heat conductive members used in power semiconductor substrates and packages, electrically conductive members, electrode members of batteries, and electronic device materials such as magnetic coils and the like.

1. A compression molding composition comprising:
an emulsion-polymerized polytetrafluoroethylene;
a heat-processible fluoropolymer; and
a filler; wherein:
a melt flow rate (MFR) of the heat-processible fluoropolymer is from 0.01 to 100 g/10 min; and
a content of the heat-processible fluoropolymer is from 1 to 40 mass % relative to a total of the emulsion-polymerized polytetrafluoroethylene and the heat-processible fluoropolymer.

2. The compression molding composition according to claim 1, wherein the heat-processible fluoropolymer includes a polymer selected from a group consisting of polytetrafluoroethylenes, tetrafluoroethylene perfluoro (alkyl vinyl ether) copolymers, tetrafluoroethylene hexafluoropropylene copolymers, tetrafluoroethylene hexafluoropropylene perfluoro (alkyl vinyl ether) copolymers, tetrafluoroethylene ethylene copolymers, polyvinylidene fluorides, polychlorotrifluoroethylenes, and chlorotrifluoroethylene ethylene copolymers.

3. The compression molding composition according to claim 1, wherein the heat-processible fluoropolymer includes tetrafluoroethylene perfluoro (alkyl vinyl ether) copolymer.

4. A molded product obtained by compression molding the composition described in claim 1.

5. The molded product according to claim 4, wherein the molded product is a sliding material.

6. The molded product according to claim 4, wherein the molded product is a sealing material.

7. A method for producing the compression molding composition described in claim 1, the method comprising:
mixing the emulsion-polymerized polytetrafluoroethylene with the heat-processible fluoropolymer; and
mixing the mixture with the filler to obtain the compression molding composition.

8. A method for producing the compression molding composition described in claim 1;
the method comprising mixing the emulsion-polymerized polytetrafluoroethylene, the heat-processible fluoropolymer, and the filler to obtain the compression molding composition.
